(19) United States
(12) Patent Application Publication
(10) Pub. No.: US 2025/0100344 A1
(43) Pub. Date: Mar. 27, 2025

(54) THERMAL MANAGEMENT SYSTEM FOR ELECTRIC VEHICLES AND METHOD FOR OPERATING SAME

(71) Applicant: DENSO CORPORATION, Kariya-city (JP)

(72) Inventors: Ron PUTS, Wegberg (DE); Pietro MOSCA, Wegberg (DE)

(21) Appl. No.: 18/977,508

(22) Filed: Dec. 11, 2024

Related U.S. Application Data
(63) Continuation of application No. PCT/JP2023/021496, filed on Jun. 9, 2023.

(30) Foreign Application Priority Data
Jun. 15, 2022 (DE) 102022115096.8

(51) Int. Cl. B60H 1/00

(52) U.S. Cl. CPC B60H 1/0073; B60H 1/00278; B60H 1/00828; B60H 1/00885; B60H 2001/00307

(57) ABSTRACT

A thermal management system for an electric vehicle includes a thermal system with a control device. The control device generates lower level control outputs for operating the thermal management system based on inputs including user requests and parameters detected by a sensor device. The control device computes a cost function from the inputs to generate intermediate outputs, computes optimal control setpoints based on the intermediate outputs, and computes the lower level control outputs based on the optimal control setpoints for operating the thermal management system. The inputs are selected from a group of parameters defining target air conditions in a cabin, ambient conditions, thermal system conditions and vehicle states. The intermediate outputs comprise coefficient of performance of the thermal system and/or power consumption parameters of electric components. The optimal control setpoints comprise operating parameters of the thermal systems and/or temperature conditions.

### CROSS REFERENCE TO RELATED APPLICATIONS

The present application is a continuation application of International Patent Application No. PCT/JP2023/021496 filed on Jun. 9, 2023, which designated the U.S. and claims the benefit of priority from German Patent Application No. 102022115096.8 filed on Jun. 15, 2022. The disclosures of all the above applications are incorporated herein.

### TECHNICAL FIELD

The present disclosure relates to an electric vehicle thermal management system and a method for operating same.

### BACKGROUND

In battery operated electric vehicles, driving range and drivers comfort requirements lead to more and more efficient thermal systems in electric vehicle.

### SUMMARY

According to an aspect of the present disclosure, a thermal management system for an electric vehicle with a cabin includes a thermal system with a sensor device and a control device. The sensor device is configured to detect ambient parameters, and operating parameters and conditions of the thermal system and the electric vehicle. The control device is configured to generate lower level control outputs for operating the thermal management system based on control device inputs including user requests and parameters detected by the sensor device. The thermal system includes cooling and heating components with and without electric driven components and electric driven auxiliary components. The control device includes a data driven supervised learning model unit, a control optimization unit, and a lower level control unit. The inputs of the control device are applied to the data driven supervised learning model unit. The data driven supervised learning model unit is configured to compute a cost function in an optimization domain for the control optimization unit and to generate calculated intermediate outputs. The control optimization unit is configured to compute optimal control setpoints for the lower level control unit. The lower level control unit is configured to compute the lower level control outputs for operating the thermal management system. The inputs to the control device are selected from a group of parameters defining target air conditions in the cabin, ambient conditions, thermal system conditions and vehicle states. The calculated intermediate outputs of the data driven supervised learning model unit comprise coefficient of performance of the thermal system and/or power consumption parameters of electric components. The optimal control setpoints for the lower level control unit comprise operating parameters of the thermal systems and/or temperature conditions.

### BRIEF DESCRIPTION OF THE DRAWINGS

The drawings described herein are for illustrative purposes only and are not intended to limit the scope of the present disclosure. Corresponding reference numerals indicate corresponding parts throughout the several views of the drawings.

FIG. 1 illustrates a H/P system for heating and cooling the cabin air as part of the thermal system to be managed and controlled by the thermal management system.

FIG. 2 illustrates an electric power train/battery coolant system for keeping electric powertrain and battery in desired temperature ranges.

FIG. 3 illustrates a control device controlling the thermal system as shown in FIGS. 1 and 2.

FIG. 4 illustrates a first embodiment of the disclosure applied when heating of the cabin is requested.

FIG. 5 illustrates a second embodiment of the disclosure applied when dehumidification of the cabin is requested.

FIG. 6 illustrates a third embodiment of the disclosure applied when cooling of the cabin is requested.

FIG. 7 illustrates a fourth embodiment of the disclosure being a generalized H/P system control.

FIG. 8 illustrates a fifth embodiment of the disclosure applied to keep the electric powertrain/battery coolant system within appropriate temperature ranges under conditions imposed by the driver, ambient conditions vehicle component specifications.

FIG. 9 illustrates a sixth embodiment with a modified H/P system.

FIG. 10 illustrates a seventh embodiment with an additional interconnection between H/P system and electric powertrain/battery coolant system.

### DETAILED DESCRIPTION

In battery operated electric vehicles driving range and drivers comfort requirements lead to more and more efficient thermal systems in electric vehicle. This increases complexity of thermal management systems in electric vehicles and its control. It is thus desirable to apply advanced control techniques to increase efficiency of thermal managements systems of electric vehicles. Current state-of-the-art thermal systems contain many actuators that are controlled to realize a target temperature in cabin, battery, and electric powertrain. According to a comparative example, to realize the required heating power with minimum energy losses, a lot of testing is performed under many different conditions to calibrate the system, which increases the calibration efforts significantly. Found calibrations are stored into lookup maps and a control is being configured. Despite all calibration efforts not always full optimal controls can be guaranteed in the complete operation domain.

A heat exchanger system is used for cooling purpose in large industrial applications. To increase efficiency of the heat exchanger system, a supervised learning model can be applied to determine optimal operating parameters for a specific cooling application.

It is thus an object of the present disclosure to provide an electric vehicle thermal management system and a method for operating same which applies supervised learning to achieve an optimal balance between user comfort and driving range.

This object is solved by electric vehicle thermal management system according to the present disclosure.

The AI based control approach according to the disclosure generates final control device output operating the thermal management system with minimum energy consumption and maximum COP considering the user requests for driving speed, cabin temperature and the conditions of the selected driving route. A continuous high efficiency electric vehicle thermal management system is provided, with a thermal system including a refrigerant loop and/or a coolant loop and a control device. The refrigerant system is also known as an air-conditioning system or heat pump system (H/P system). The heat-pump is a key thermal system to condition, heat or cool, the vehicle's cabin to a comfortable temperature range and/or to condition, heat or cool, the high voltage battery to an optimal working condition. The coolant system is required to condition the electric powertrain and the battery in most optimal and robust temperature range. The control device applies a data driven supervised learning model in combination with a control optimization providing optimal control setpoints to a standard lower level control. The AI based control device ensures optimal efficiency of the refrigerant or coolant system automatically, under all conditions, increasing the electric vehicle's range. The AI based control device is significantly reducing the calibration efforts as it allows for automatic training of AI models offline, e.g. using neural networks. A digital twin of the thermal plant is trained using supervised learning methods. Data which is used from training can come from an accurate simulation environment which allows for efficient data generation by fast and continuous operation of the simulation plant. Other possibility is to retrieve the data directly from the target vehicle. When the supervised learning model is trained, it can be used as function call for the optimum control problem. Both the trained model as well as the optimization method can run real time such that it can continuously guarantee optimality.

The disclosure has the following benefits:
Optimal system performance guaranteed, i.e. efficiency;
Reduced calibration efforts as it replaces current map-based calibrations;
Modular, easy to update by re-training of the model using updated datasets.

For the data driven supervised learning model preferably an artificial neural network is applied. For the optimization in control optimization preferably swarm optimization or the gradient decent method is applied.

The present disclosure may be directed to a thermal management system with a thermal system comprising an H/P system to condition, heat or cool, the vehicle's cabin to a comfortable temperature range considering the battery state of charge, ambient conditions, H/P system conditions and vehicle states.

The condenser device comprises an inner condenser arranged in the HVAC channel with an inner condenser power and/or an outer condenser arranged outside the HVAC channel with an outer condenser power in coolant side connection with a heat core arranged in the HVAC channel.

The present disclosure may define the most appropriate input parameters to the control device with the data driven supervised learning model with optimization algorithm.

The present disclosure may define preferred target power calculation device used as input to the data driven supervised learning model.

The present disclosure may define the most appropriate optimal control setpoints output by the optimization algorithm/unit and input to the lower level.

The present disclosure may define the most appropriate lower level control outputs used to operate and control the thermal management system.

The present disclosure may be directed to a thermal management system with a thermal system comprising an electric powertrain cooling system to condition and operate the electric powertrain and the battery in most optimal and robust temperature range.

According to the present disclosure, the outer condenser coolant loop may be connected with the powertrain/battery coolant loop.

The present disclosure may define the most appropriate inputs, intermediate outputs and the optimal control setpoints for the lower level control unit/algorithm when the H/P system is operated in the heating mode to heat up the cabin air.

The present disclosure may define the most appropriate inputs, intermediate outputs and the optimal control setpoints for the lower level control unit/algorithm when the H/P system is operated in the dehumidification mode to re-heat and dehumidify the previously cooled cabin air.

The present disclosure may define the most appropriate inputs, intermediate outputs and the optimal control setpoints for the lower level control unit/algorithm when the H/P system is operated in the cooling mode to cool the cabin air.

Example embodiments will now be described more fully with reference to the accompanying drawings. The following description is merely exemplary in nature and is not intended to limit the present disclosure, application, or uses.

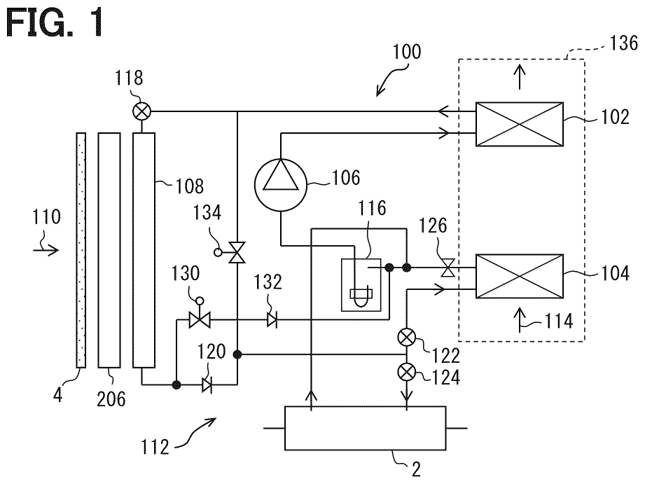

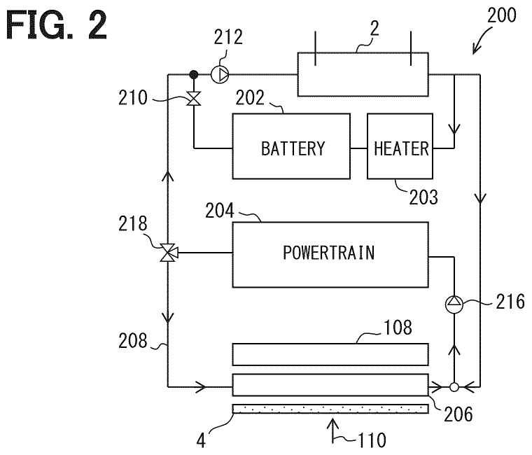

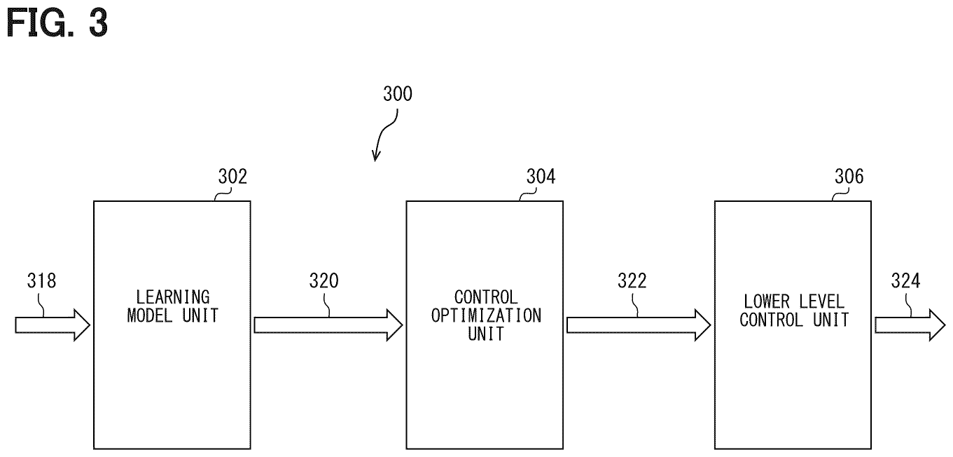

FIG. 1 shows a heat pump or H/P system 100 for heating and cooling the cabin air, FIG. 2 shows an electric powertrain/battery coolant system 200 for keeping electric powertrain and battery in desired temperature ranges and FIG. 3 shows control device 300 for controlling the thermal management system.

The H/P system 100 comprises a chiller 2, an inner condenser 102 (an example of condenser device), an evaporator 104, a compressor 106, and an outer heat exchanger 108 with a fan 110 interconnected via a refrigerant loop 112 and an air blower 114 for air as cooling fluid to evaporator 104 and inner condenser 102. Furthermore, an accumulator 116 is provided for storing liquid refrigerant and for separating liquid and gaseous refrigerant. The outlet of compressor 106 is connected to the inlet of inner condenser 102. The outlet of inner condenser 102 is connected to an outer heat exchanger expansion valve 118 which in turn is connected to the inlet of outer heat exchanger 108. An opening ratio of the outer heat exchanger expansion valve 118 is referenced as EXV_{OHX} (corresponding to outer heat exchanger expansion valve opening ratio). The outlet of outer heat exchanger 108 is connected via a first check valve 120 to a point between an evaporator expansion valve 122 and a chiller expansion valve 124. An opening ratio of the evaporator expansion valve 122 is referenced as EXV_{EVA} (corresponding to evaporator expansion valve opening ratio). An opening ratio of the chiller expansion valve 124 is referenced as EXV_{CHI} (corresponding to chiller expansion valve opening ratio). The chiller expansion valve 124 in turn is connected to the refrigerant inlet of chiller 2. The evaporator expansion valve 122 in turn is connected to the inlet of evaporator 104. The outlet of evaporator 104 is connected to the inlet of accumulator 116 via a pressure regulator valve 126. The refrigerant outlet of chiller 2 is also connected to the inlet of accumulator 116. Via a dehumidification control valve 130 (an example of dehumidification valve device) and a second check valve 132 the outlet of outer heat exchanger 108 is likewise connected to the inlet of accumulator 116. A point between the outer heat exchanger expansion valve 118 and the outlet of inner condenser 102 is connected via a heating control valve 134 (an example of heating valve device) to a point between the first check valve 120 and the chiller expansion valve 124 or evaporator expansion valve 122. The inner condenser 102 and evaporator 104 are arranged in a heating-cooling-air-conditioning or HVAC channel 136 entering into the vehicle cabin.

The electric power train/battery coolant system 200 shown in FIG. 2 comprises the coolant side of chiller 2, a battery 202, a battery heater 203 (i.e., electric battery heater), an electric powertrain 204 and a radiator 206 interconnected via a powertrain/battery coolant loop 208. The powertrain/battery coolant loop 208 connects the coolant outlet of chiller 2 with the coolant inlet of battery heater 203. The coolant outlet of the battery heater 203 is connected to coolant inlet of battery 202. The coolant outlet of battery 202 is connected to the coolant inlet of chiller 2 via a two-way-valve 210 (an example of valve device) and a first pump 212 (an example of coolant pump device). The coolant outlet of chiller 2 is likewise connected to the coolant inlet of electric power train 204 and a second pump 216 (an example of coolant pump device). Via a 3-way-valve 218 (an example of valve device) the coolant outlet of electric powertrain 204 is connected to the first pump 212 and the coolant inlet of radiator 206. As is shown in FIGS. 1 and 2 the outer heat exchanger 108 and the radiator 206 with air fan 110 and an active grill shutter 4 are arranged as a stack.

The control device 300 comprises a data driven supervised learning model unit 302, a control optimization unit 304 and a lower level control unit 306. Control device inputs 318 are applied to the data driven supervised learning model unit 302. The data driven supervised learning model unit 302 uses a data driven supervised learning model to compute a cost function in an optimization domain as intermediate outputs 320 to the control optimization unit 304. The optimization unit 304 (i.e. control optimization algorithm) computes optimal control setpoints 322 for the lower level control unit 306. The lower level control unit 306 executes a lower level control to compute the final control device output 324 (i.e. lower level control outputs) for operating the thermal management system based on the final control device output 324. The final control device output 324 corresponds to lower level control outputs.

The inputs 318 to the control device 300 and the data driven supervised learning model unit 302 are selected from a group of parameters defining target air conditions in the cabin, ambient conditions, thermal system conditions and vehicle states. The computed intermediate outputs of the data driven supervised learning model unit 302 comprise coefficient of performance COP of the thermal system and/or power consumption parameters Pxx of the electric driven components like pumps, valve actuators, fan, blower, compressor etc. The optimal control setpoints for the lower level control unit 306 comprise operating parameters, like compressor speed, blower speed valve actuation status etc. and/or temperature conditions, like cabin air temperature, battery temperature, coolant and refrigerant temperatures etc.

For the data driven supervised learning model unit 302 preferably an artificial neural network is applied. For the optimization in control optimization unit 304 preferably swarm optimization or the gradient decent method is applied.

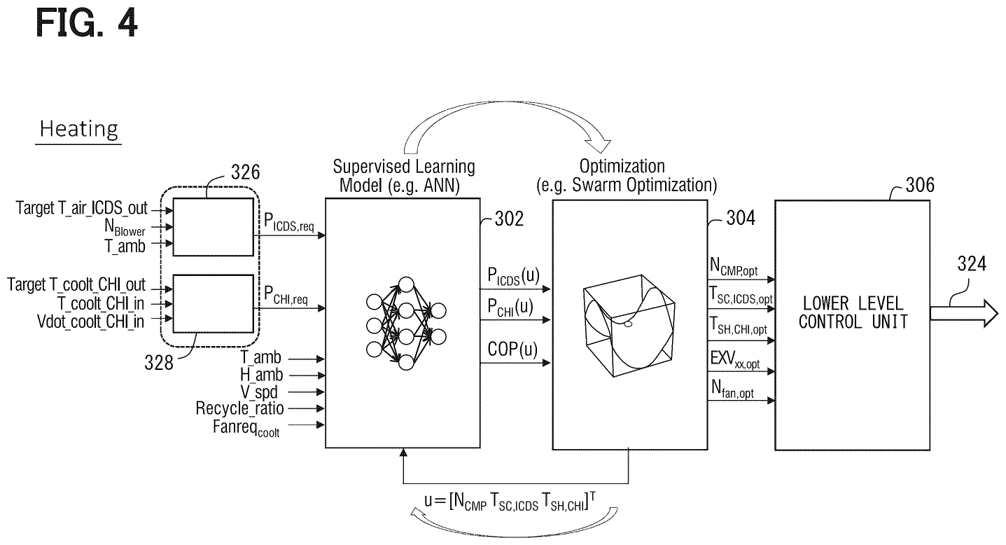

FIG. 4 illustrates a first embodiment of the disclosure when heating of the cabin is requested. For this purpose the following inputs 318 to the control device 300 have shown to be appropriate:
Target T_air_ICDS_out=Target air temperature at air outlet of inner condenser (corresponding to target inner condenser air out temperature),
N_{Blower}=air blower rotation speed (corresponding to target blower speed, blower duty/air flow),
T_amb=ambient Temperature,
Target T_coolt_CHI_out=Target coolant temperature at chiller coolant outlet (corresponding to target chiller coolant out temperature),
T_coolt_CHI_in=coolant temperature at chiller inlet (corresponding to chiller coolant in temperature),
Vdot_coolt_CHI_in=coolant volume flow into chiller (corresponding to chiller coolant in mass/volume flow),
H_amb=ambient humidity,
V_spd=vehicle driving speed,
Recycle_ratio=change rate of air in cabin (corresponding to cabin air recycling ratio), and
Fanreq_{coolt}=fan speed as requested by common HVAC control (corresponding to target fan duty rate, fan duty/speed).

From said inputs Target T_air_ICDS_out, N_{Blower} and T_amb are fed to an inner condenser power calculation device 326 which computes a target inner condenser power P_{ICDS,req} as input to the data driven supervised learning model unit 302. Inputs Target T_coolt_CHI_out, T_coolt_CHI_in and Vdot_coolt_CHI_in are fed to a chiller power calculation device 328 which computes target chiller power P_{CHI,req} as input to the data driven supervised learning model unit 302. Inner condenser power calculation device 326 and chiller power calculation device 328 can be regarded as part of the data driven supervised learning model unit 302. Inputs T_amb, H_amb, V_spd, Recycle_ratio and Fanreq_{coolt} are directly input to the data driven supervised learning model unit 302. The data driven supervised learning model unit 302 outputs calculated inner condenser power P_{ICDS}(u), calcuated chiller power P_{CHI}(u) and calculated COP(u) of the H/P system 100 as intermediate outputs 320. For the control optimization unit 304 a cost function is defined as shown in Maths. 1 to 3.

$${min}_{u} J ( u , v ) = \text{} - {w}_{1} COP ( u , v ) + {{w}_{2} ( \frac{{P}_{CHI} ( u , v )}{{P}_{CHI , req}} - 1 )}^{2} + {{w}_{3} ( \frac{{P}_{ICDS} ( u , v )}{{P}_{ICDS , req}} - 1 )}^{2} \qquad Math . 1$$

$$u = {[ {N}_{CMP} {T}_{SC , ICDS} {T}_{SH , CHI} ]}^{T} \qquad Math . 2$$

$$v = {[ T\_ambV \_spdH \_amb ]}^{T} \qquad Math . 3$$

Where w₁, w₂ and w₃ are weights that scale the effect of coefficient of performance COP, chiller power P_{CHI} and inner condenser power P_{ICDS}. COP is the ratio between the useful heating or cooling Q_{H} or Q_{C} and the work/energy put into the system Win. For heating COP=Q_{H}/Wᵢₙ.

The appropriate optimal control setpoints 322 output by the control optimization unit 304 are:
optimal compressor speed N_{CMP, opt} (corresponding to rotation speed of the compressor 106),
optimal inner condenser subcool temperature T_{SC,ICDS, opt} (corresponding to subcool temperature of the inner conenser 102), and
optimal chiller superheat temperature T_{SH,CHI, opt} (corresponding to superheat temperature of the chiller 2).

Additionally, optimal opening ratios EXV_{xx,opt} of inner condenser expansion valve 118 and chiller expansion valve 124, and optimal air fan speed N_{fan,opt} may be selected as optimal control setpoints 322.

These optimal control setpoints 322 are input the common lower level contol unit 306 wihch generates the final control device output 324.

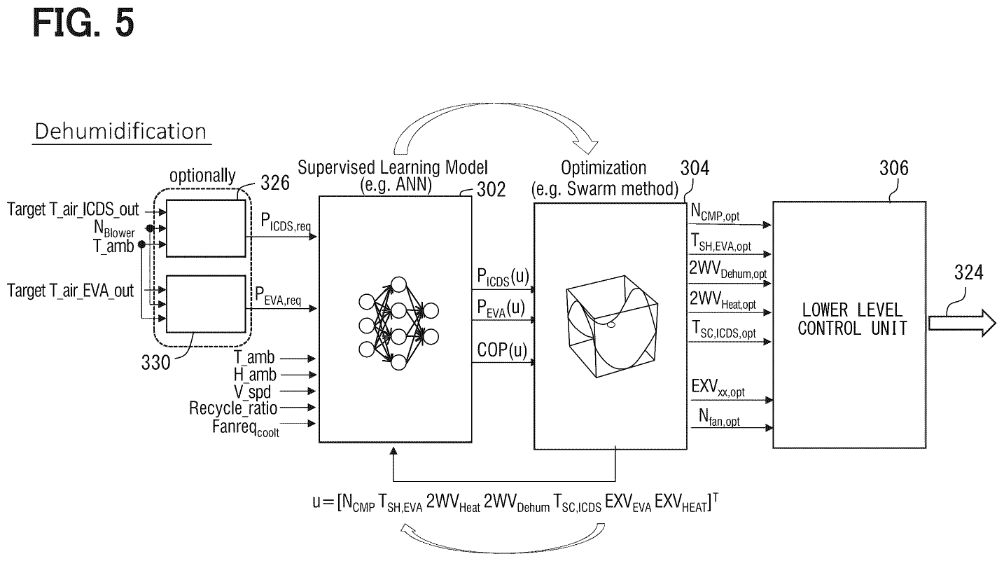

FIG. 5 illustrates a second embodiment of the disclosure when dehumidification of the cabin is requested. For this purpose, the following inputs 318 to the control device 300 have shown to be appropriate:
Target T_air_ICDS_out=Target air temperature at air outlet of inner condenser,
N_{Blower}=air blower rotation speed,
T_amb=ambient Temperature,
Target T_air_EVA_out=Target air temperature at evaporator air outlet (corresponding to target evaporator air out temperature),
H_amb=ambient humidity,
V_spd=vehicle driving speed,
Recycle_ratio=change rate of air in cabin, and
Fanreq_{coolt}=fan speed as requested by common HVAC control.

From said inputs Target T_air_ICDS_out, N_{Blower} and T_amb are fed to the inner condenser power calculation device 326 which computes a target inner condenser power P_{ICDS,req} as input to the data driven supervised learning model unit 302. Inputs Target T_air_EVA_out, N_{Blower} and T_amb are fed to an evaporator power calculation device 330 which computes target target evaporator power P_{EVA,req} as input to the data driven supervised learning model unit 302. Inner condenser power calculation device 326 and evaporator power calculation device 330 can be regarded as part of the data driven supervised learning model unit 302. Inputs T_amb, H_amb, V_spd, Recycle_ratio and Fanreq_{coolt} are directly input to the data driven supervised learning model unit 302. The data driven supervised learning model unit 302 outputs calculated inner condenser power P_{ICDS}(u), calcuated evaporator power P_{EVA}(u) and calculated COP(u) of the H/P system 100 as intermediate outputs 320. For the control optimization unit 304 a cost function is defined as shown in Maths.4 to 6.

$${min}_{u} J ( u , v ) = \text{} - {w}_{1} COP ( u , v ) + {{w}_{2} ( \frac{{P}_{EVA} ( u , v )}{{P}_{EVA , req}} - 1 )}^{2} + {{w}_{3} ( \frac{{P}_{ICDS} ( u , v )}{{P}_{ICDS , req}} - 1 )}^{2} \qquad Math . 4$$

$$u = {[ {N}_{CMP} {T}_{SH , EVA} 2 {WV}_{Heat} 2 {WV}_{Dehum} {T}_{SH , ICDS} {EXV}_{EVA} {EXV}_{HEAT} ]}^{T} \qquad Math . 5$$

$$v = {[ T\_ambV \_spdH \_amb ]}^{T} \qquad Math . 6$$

Where w₁, w₂ and w₃ are weights that scale the effect of coefficient of performance COP, chiller power P_{CHI} and inner condenser power P_{ICDS}.

The appropriate optimal control setpoints 322 output by the control optimization unit 304 are:
optimal compressor speed N_{CMP, opt},
optimal evaporator superheat temperature T_{SH,EVA, opt} (corresponding to superheat temperature of the evaporator 104),
status (i.e., condition) 2WV_{Dehum, opt} of dehumidification control valve 134, and
status (i.e., condition) 2WV_{Heat, opt} of heating control valve 130.

Additionally,
optimal inner condenser subcool temperature T_{SC,ICDS, opt},
optimal opening ratios EXV_{xx,opt} of inner condenser expansion valve 118 and
evaporator expansion valve 122, and
optimal air fan speed N_{fan,opt}
may be selected as optimal control setpoints 322.

These optimal control setpoints 322 are input to the common lower level contol unit 306 wihch generates the final control device output 324.

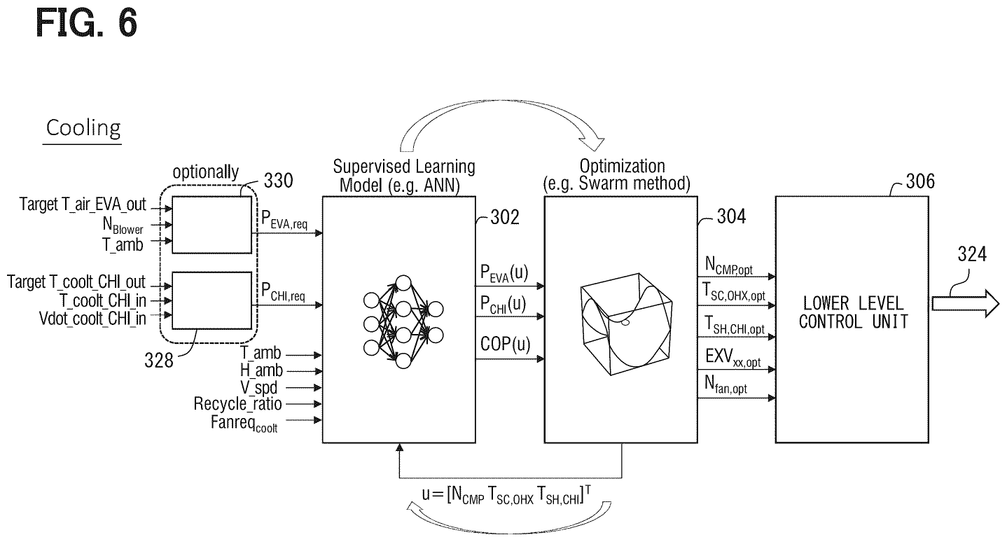

FIG. 6 illustrates a third embodiment of the disclosure when cooling of the cabin is requested. For this purpose, the following inputs 318 to the control device 300 have shown to be appropriate:
Target T_air_EVA_out=Target air temperature at evaporator air outlet,
N_{Blower}=air blower rotation speed,
T_amb=ambient Temperature,
Target T_coolt_CHI_out=Target coolant temperature at chiller coolant outlet,
T_coolt_CHI_in=coolant temperature at chiller inlet,
Vdot_coolt_CHI_in=coolant volume flow into chiller,
H_amb=ambient humidity,
V_spd=vehicle driving speed,

Recycle_ratio=change rate of air in cabin, and
Fanreq_{coolt}=fan speed as requested by common HVAC control.

From said inputs target T_air_EVA_out, N_{Blower} and T_amb are fed to an evaporator power calculation device 330 which computes target evaporator power P_{EVA,req} as input to the data driven supervised learning model unit 302. Inputs target T_coolt_CHI_out, T_coolt_CHI_in and Vdot_coolt_CHI_in are fed to a chiller power calculation device 328 which computes target chiller power P_{CHI,req} as input to the data driven supervised learning model unit 302. Inputs T_amb, H_amb, V_spd, Recycle_ratio and Fanreq_{coolt} are directly input to the data driven supervised learning model unit 302. The data driven supervised learning model unit 302 outputs calculated evaporator power P_{EVA}(u), calcuated chiller power P_{CHI}(u) and calculated COP(u) of the H/P system 100 as intermediate outputs 320. For the control optimization unit 304 a cost function is defined as shown in Maths. 7 to 9.

$${min}_{u} J ( u , v ) = \text{} - {w}_{1} COP ( u , v ) + {{w}_{2} ( \frac{{P}_{EVA} ( u , v )}{{P}_{EVA}^{*}} - 1 )}^{2} + {{w}_{3} ( \frac{{P}_{CHI} ( u , v )}{{P}_{CHI}^{*}} - 1 )}^{2} \qquad Math . 7$$

$$u = {[ {N}_{CMP} {T}_{SC , OHX} {T}_{SH , CHI} ]}^{T} \qquad Math . 8$$

$$v = {[ T\_ambV \_spdH \_amb ]}^{T} \qquad Math . 9$$

The appropriate optimal control setpoints 322 output by the control optimization unit 304 are:
optimal compressor speed N_{CMP, opt},
optimal outer heat exchanger subcool temperature T_{SC,OHX, opt} (corresponding to subcool temperature of the outer heat exchanger 108), and
optimal chiller superheat temperature T_{SH,CHI, opt}.

Additionally,
optimal opening ratios EXV_{xx,opt} of outer heat exchanger expansion valve 118 and chiller expansion valve 124, and
optimal air fan speed N_{fan,opt}
may be selected as optimal control setpoints 322.

These optimal control setpoints 322 are input the common lower level contol unit 306 wihch generates the final control device output 324.

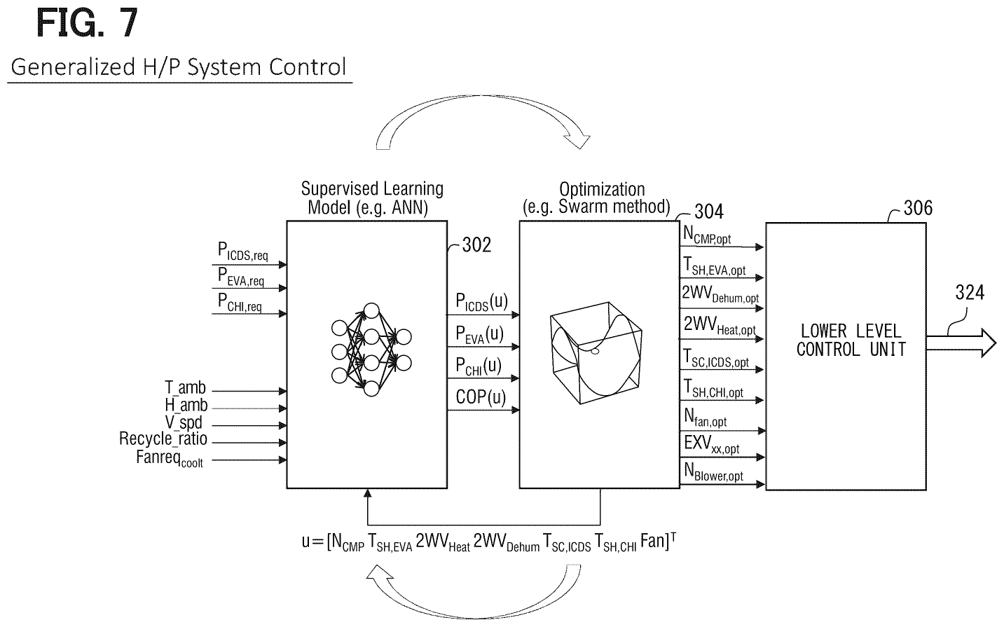

FIG. 7 is a generalized H/P system control and is essentially a combination of first, second and third embodiment. For this purpose the following inputs 318 to the control device 300 have shown to be appropriate:
Target T_air_ICDS_out=Target air temperature at air outlet of inner condenser,
N_{Blower}=air blower rotation speed (corresponding to blower duty/air flow),
T_amb=ambient Temperature,
Target T_air_EVA_out=Target air temperature at evaporator air outlet,
Target T_coolt_CHI_out=Target coolant temperature at chiller coolant outlet,
T_coolt_CHI_in=coolant temperature at chiller inlet,
Vdot_coolt_CHI_in=coolant volume flow into chiller,
H_amb=ambient humidity,
V_spd=vehicle driving speed,
Recycle_ratio=change rate of air in cabin, and
Fanreq_{coolt}=fan speed as requested by common HVAC control.

With inner condenser power calculation device 326, chiller power calculation device 328 and evaporator power calculation device 330 which are not shown in FIG. 7, the target inner condenser power P_{ICDS,req}, the target chiller power P_{CHI,req} and the target evaporator power P_{EVA,req} are computed and input to the data driven supervised learning model unit 302. Inputs T_amb, H_amb and V_spd are directly input to the data driven supervised learning model unit 302. Additionally Recycle_ratio and Fanreq_{coolt} may be chosen as control device input 318 input to the data driven supervised learning model unit 302.

The data driven supervised learning model unit 302 outputs calculated inner condenser power power P_{ICDS}(u), calculated evaporator power P_{EVA}(u), calcuated chiller power P_{CHI}(u) and calculated COP(u) of the H/P system 100 as intermediate outputs 320. For the control optimization unit 304 a cost function is defined as shown in Maths. 10 to 12.

$${min}_{u} J ( u , v ) = - {w}_{1} COP ( u , v ) + {{w}_{2} ( \frac{{P}_{CHI} ( u , v )}{{P}_{CHI}^{*}} - 1 )}^{2} + {{w}_{3} ( \frac{{P}_{ICDS} ( u , v )}{{P}_{ICDS}^{*}} - 1 )}^{2} + {{w}_{4} ( * \frac{{P}_{EVA} ( u , v )}{{P}_{EVA}} - 1 )}^{2} \qquad Math . 10$$

$$u = {[ {N}_{CMP} {T}_{SH , EVA} 2 {WV}_{Dehum} 2 {WV}_{Heat} {T}_{SC , ICDS} {T}_{SH , CHI} Fan ]}^{T} \qquad Math . 11$$

$$v = {[ T\_ambV \_spdH \_amb ]}^{T} \qquad Math . 12$$

The appropriate optimal control setpoints 322 output by the control optimization unit 304 are:
optimal compressor speed N_{CMP,opt},
optimal evaporator superheat temperature T_{SH,EVA,opt},
optimal inner condenser subcool temperature T_{SC,ICDS, opt},
optimal chiller superheat temperature T_{SH,CHI, opt},
optimal air fan speed N_{fan,opt},
status 2WV_{dehum, opt} of dehumidification control valve 134, and
status 2WV_{heat, opt} of heating control valve 130.

Additionally,
optimal opening ratios EXV_{xx,opt} of outer heat exchanger expansion valve 118, chiller expansion valve 124 and evaporator expansion valve 122, and
optimal air blower rotation speed N_{Blower, opt}
may be selected as optimal control setpoints 322.

These optimal control setpoints 322 are input the common lower level contol unit 306 wihch generates the final control device output 324.

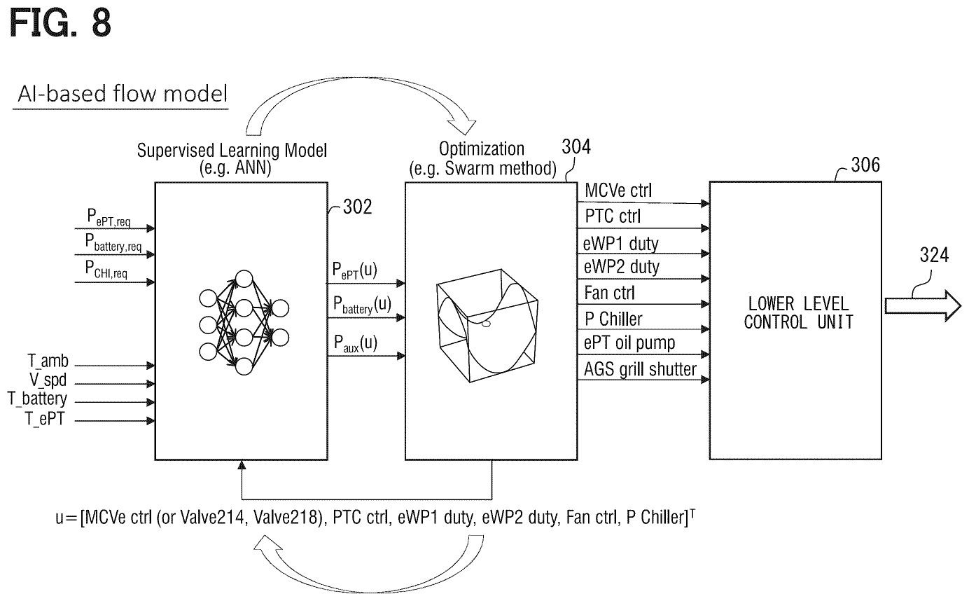

FIG. 8 illustrates a fifth embodiment of the disclosure applied to keep the electric powertrain/battery coolant system within appropriate temperature ranges under conditions imposed by the driver, ambient conditions vehicle component specifications. For this purpose, the following inputs 318 to the control device 300 have shown to be appropriate:
ambient temperature T_amb,
vehicle driving speed V_spd,
battery temperature T_battery,
electric powertrain temperature T_ePT,
target chiller power P_{CHI,req} (i.e. requested chiller power),
target power for electric powertrain P_{ePT,req} (i.e. requested power for electric power train), and
target battery power P_{battery,req} (i.e. requested battery power).

The data driven supervised learning model unit 302 outputs calculated power consumption P_{ePT}(u) of the electric powertrain 204, calculated power output P_{battery}(u) (i.e., calculated power dispense) of the battery 202 and calculated power consumption Pₐᵤₓ(u) of electric driven auxiliary components. Where Pₐᵤₓ is the power consumption of all electric driven components like fan, blower, water pumps, valve actuators etc. For the control optimization unit 304, a cost function is defined as shown in Maths. 13 to 15.

$${min}_{u} J ( u , v ) = {{w}_{1} ( \frac{{P}_{battery , req} - {P}_{battery} ( u , v )}{{P}_{battery , req}} )}^{2} + {{w}_{2} ( {P}_{aux} )}^{2} \qquad Math . 13$$

$$u = [ \begin{matrix}MCVe ctrl ( or Valve 214 , Value 218 ) , PTC ctrl , \\ eWP 1 duty , eWP 2 duty , Fan ctrl , P Chiller\end{matrix} ] \qquad Math . 14$$

$$v = {[ T\_ambV \_spdT \_ePTT \_battery ]}^{T} \qquad Math . 15$$

The appropriate optimal control setpoints 322 output by the control optimization unit 304 are:
optimal valve control setpoints MCVe ctrl (corresponding to optimal valve device control parameter),
optimal battery heater control PTC ctrl (corresponding to optimal electric heater control parameter),
optimal first water pump 212 duty eWP1 duty,
optimal second water pump 216 duty eWP2 duty, and
optimal fan control Fan ctrl.

Additionally,
an optimal eletric powertrain oil duty ePT oil pump, and
an optimal active grill shutter control AGS grill shutter,
an optimal auxiliary components control parameter Aux ctrl, and
an optimal chiller power P_{CHI, opt}
may be selected as optimal control setpoints 322.

In the electric powertrain/battery coolant system as shown in FIG. 2 a two-way-valve 210 and athree-way-valves 218 are applied. Instead of said single valves a multi control valve arrangement may be applied.

In any embodiment optimization control unit 304 computes the optimal control setpoints causing the thermal management system to operate with minimum energy consumption and maximum COP taking into account the user requests for speed, cabin temperature and the conditions of the selected driving route.

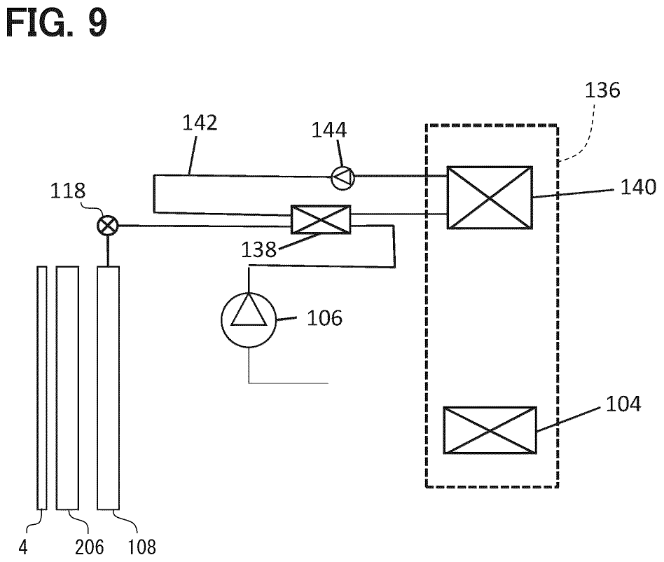

FIG. 9 illustrates a sixth embodiment with a modified H/P system where, instead of the inner condenser 102, an outer condenser 138 (an example of condenser device) arranged outside the HVAC channel 136 and a heat core 140 arranged inside the HVAC channel 136 are applied. The outer condenser 138 and the heat core 140 are interconnected via an outer condenser coolant loop 142 with a coolant pump 144. The heat core 140 in the HVAC channel 136 is a liquid/air heat exchanger for heating the cabin air with heat from the outer condenser 138.

When using an outer condenser 138, the control parameters corresponding to the control parameters of the inner condenser 102 are:
P_{OCDS,req}=target outer condenser power,
P_{OCDS} (u)=calculated outer condensor power output,
T_coolt_OCDS_out=target outer condenser coolant out temperature,
T_{SC,OCDS}=outer condenser subcool temperature (corresponding to subcool temperature of the outer conenser 138),
coolant volume flow rate in the outer condenser coolant loop 142 (i.e., target volume flow rate of colant through the outer condenser 138), and coolant pump duty rate.

These parameters have to be input and optimized in the control device 300. Inputs Target T_air_OCDS_out, T_amb and coolant flow volume through the outer condenser 138 are fed to an outer condenser power calculation device which computes the target outer condenser power P_{OCDS,req} as input to the data driven supervised learning model unit 302.

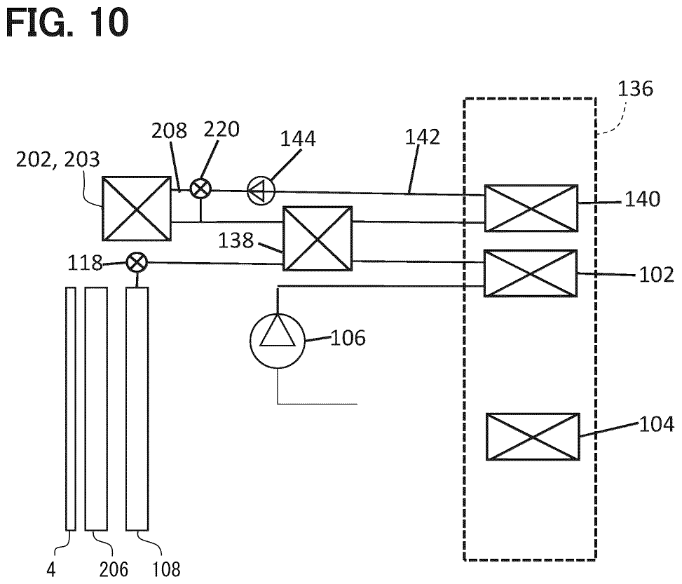

FIG. 10 illustrates a seventh embodiment where the heat core 140 does not replace the inner condenser 102 but is provided in addition. Furthermore, the outer condenser coolant loop 142 is connected with the powertrain/battery coolant loop 208. The heat core 140 heats the cabin air with heat from the outer condenser and from the electric powertrain 204 and/or battery 202. However, with a bypass with bypass valve 220, powertrain/battery coolant loop 208 and outer condenser coolant loop 142 may be separated.

The embodiments of FIGS. 9 and 10 are based on the the H/P system 100 and the electric powertran/battery coolant system 200. In FIGS. 9 and 10, basically only the additional and changed parts are shown. The not shown parts in FIGS. 9 and 10 are elements of the sixth and seventh embodiment.

The control device and methods described in this application may be fully implemented by a special purpose computer created by configuring a processor programmed to execute one or more particular functions embodied in computer programs.

What is claimed is:

1. A thermal management system for an electric vehicle with a cabin, comprising
a thermal system with a sensor device configured to detect ambient parameters, and operating parameters and conditions of the thermal system and the electric vehicle, and a control device configured to generate lower level control outputs for operating the thermal management system based on control device inputs including user requests and parameters detected by the sensor device, wherein
the thermal system includes cooling and heating components with and without electric driven components and electric driven auxiliary components,
the control device includes
a data driven supervised learning model unit,
a control optimization unit, and
a lower level control unit,
the inputs of the control device are applied to the data driven supervised learning model unit,
the data driven supervised learning model unit is configured to compute a cost function in an optimization domain for the control optimization unit and to generate calculated intermediate outputs,
the control optimization unit is configured to compute optimal control setpoints for the lower level control unit,
the lower level control unit is configured to compute the lower level control outputs for operating the thermal management system,
the inputs to the control device are selected from a group of parameters defining target air conditions in the cabin, ambient conditions, thermal system conditions and vehicle states,
the calculated intermediate outputs of the data driven supervised learning model unit comprise coefficient of performance of the thermal system and/or power consumption parameters of electric components, and
the optimal control setpoints for the lower level control unit comprise operating parameters of the thermal system and/or temperature conditions.

2. The thermal management system according to claim 1,
wherein the thermal system comprises a H/P system with a chiller, a condenser device, an evaporator arranged in an HVAC, a compressor, and an outer heat exchanger with a fan interconnected via a refrigerant loop and an air blower for air as cooling fluid to evaporator and inner condenser and a heating valve device and a dehumidification valve device,
wherein the calculated intermediate outputs of the data driven supervised learning model unit comprise
coefficient of performance of the H/P system and two parameters selected from the group of parameters:
calculated condenser power,
calculated chiller power, and
calculated evaporator power of performance,
and wherein the optimal control setpoints for the lower level control unit comprise a rotation speed of the compressor and one temperature parameter.

3. The thermal management system according to claim 2,
wherein the condenser device comprises an inner condenser arranged in an HVAC channel with an inner condenser power and/or an outer condenser arranged outside the HVAC channel with an outer condenser power in coolant side connection with a heat core arranged in the HVAC channel for heating cabin air.

4. The thermal management system according to claim 2,
wherein the inputs to the control device are selected from the following group of parameters:
ambient temperature,
ambient humidity,
vehicle driving speed,
cabin air recycling ratio,
target fan duty rate,
target inner condenser air out temperature,
target outer condenser coolant out temperature
target evaporator air out temperature,
target blower speed,
target chiller coolant out temperature,
chiller coolant in temperature, and
chiller coolant in mass/volume flow.

5. The thermal management system according to claim 4, further comprising an inner condenser power calculation device configured to calculate a target inner condenser power based on the target inner condenser air out temperature, the ambient temperature, and the target blower speed.

6. The thermal management system according to claim 4, further comprising an evaporator power calculation device configured to calculate a target evaporator power based on the target evaporator air out temperature, the ambient temperature, and the target blower speed.

7. The thermal management system according to claim 4, further comprising an outer condenser power calculation device configured to calculate a target outer condenser power based on the target outer condenser coolant out temperature, the ambient temperature, and coolant flow volume through the outer condenser.

8. The thermal management system according to claim 4, further comprising a chiller power calculation device configured to calculate a target chiller power based on the target chiller coolant out temperature, the chiller coolant in temperature and the chiller coolant in mass/volume flow.

9. The thermal management system according to claim 2,
wherein the optimal control setpoints of the control optimization unit are selected from the following group of operating parameters of the thermal management system:
the rotation speed of the compressor,
superheat temperature of the evaporator,
subcool temperature of the inner condenser,
subcool temperature of the outer condenser,
subcool temperature of the outer heat exchanger,
superheat temperature of chiller,
chiller expansion valve opening ratio, and
target fan duty rate.

10. The thermal management system according to claim 2,
wherein the lower level control outputs of the lower level control unit are selected from the following group of operating parameters of the thermal management system:
condition of the heating valve device,
condition of the dehumidification valve device,
evaporator expansion valve opening ratio,
outer heat exchanger expansion valve opening ratio,
chiller expansion valve opening ratio,
target blower speed,
target volume flow rate of coolant through an outer condenser, and
fan duty/speed.

11. The thermal management system according to claim 1,
wherein the thermal system comprises an electric powertrain/battery coolant system comprising an electric powertrain, a battery, valve device, coolant pump device, an electric battery heater, a chiller and a radiator with a fan interconnected via a powertrain/battery coolant loop,
wherein the inputs to the control device include:
ambient temperature,
vehicle driving speed,
battery temperature,
electric powertrain temperature,
target chiller power,
target power for electric powertrain, and
target battery power,
wherein the calculated intermediate outputs of the data driven supervised learning model unit include:
calculated power consumption of the electric powertrain,
calculated power dispense of the battery, and
calculated power consumption of the electric driven auxiliary components,
and wherein the optimal control setpoints for the lower level control unit include:
optimal valve device control parameter,
optimal electric heater control parameter,
optimal auxiliary components control parameter, and
optimal chiller power.

12. The thermal management system according to claim 11,
wherein powertrain/battery coolant loop is connected with an outer condenser coolant loop, and
wherein a coolant inlet of heat core is connected to a coolant outlet of outer condenser.

13. A method of operating the thermal management system according to claim 1, comprising:
using a data driven supervised learning model to compute a cost function in the optimization domain in order to provide optimal control setpoints for a lower level control,
wherein, based on the inputs to the control device, the data driven supervised learning model (302) generates intermediate outputs forming inputs to the control optimization unit,
wherein the control optimization unit generates the optimal control setpoints used to generate lower level control outputs as operation parameters of the thermal management system,
wherein the inputs to the control device are selected from a group of parameters defining target air conditions in the cabin, ambient conditions, thermal system conditions and vehicle states,
wherein the intermediate outputs of the data driven supervised learning model comprise coefficient of performance of the thermal system and/or power consumption parameters of the electric components,
and wherein the optimal control setpoints for the lower level control comprise operating parameters of the thermal system and/or temperature conditions.

14. The method according to claim 13,
wherein the thermal system is an H/P system,
wherein the calculated intermediate outputs of the data driven supervised learning model comprise at least the calculated coefficient of performance of the H/P system and two parameters selected from the following group of parameters:
calculated inner condenser power,
calculated outer condenser power
calculated chiller power, and
calculated evaporator power,
and wherein the optimal control setpoints for the lower level control comprise a rotation speed of a compressor and one temperature parameter.

15. The method according to claim 14,
wherein the inputs to the supervised learning model are selected from the following group of parameters:
ambient temperature,
ambient humidity,
vehicle driving speed,
cabin air recycling ratio ratio,
target fan duty rate,
target inner condenser air out temperature,
target outer condenser coolant out temperature,
target evaporator air out temperature,
target blower speed,
target chiller coolant out temperature,
chiller coolant in temperature, and
chiller coolant in mass/volume flow.

16. The method according to claim 14,
wherein the optimal control setpoints of the control optimization unit are selected from the following group of operating parameters of the thermal management system:
rotation speed of the compressor,
superheat temperature of an evaporator,
subcool temperature of an inner condenser,
subcool temperature of an outer heat exchanger,
superheat temperature of a chiller,
chiller expansion valve opening ratio, and
target fan duty rate.

17. The method according to claim 14,
wherein the lower level control outputs of the lower level control are selected from the following group of operating parameters of the thermal management system:
condition of a heating valve device,
condition of a dehumidification valve device,
evaporator expansion valve opening ratio,
outer heat exchanger expansion valve opening ratio,
chiller expansion valve opening ratio,
target blower duty/speed, and
fan duty/speed.

18. The method according to claim 14, in a heating mode,
wherein the inputs to the supervised learning model comprise the following parameters:
target inner condenser air out temperature,
target blower speed,
target chiller coolant out temperature,
the chiller coolant in temperature,
the chiller coolant in mass/volume flow,
ambient temperature,
ambient humidity,
vehicle driving speed,
cabin air recycling ratio, and
target fan duty rate,
wherein the intermediate outputs of the supervised learning model contain:
the calculated inner condenser power,
the calculated chiller power, and
the calculated coefficient of performance of the H/P system,
and wherein the optimal control setpoints for the lower level control comprise:
rotation speed of the compressor,
superheat temperature of an evaporator, and
subcool temperature of an inner condenser.

19. The method according to claim 14, in a dehumidification mode,
wherein the inputs to the supervised learning model are the following parameters:
target inner condenser air out temperature,
target evaporator air out temperature,
target blower speed,
ambient temperature,
ambient humidity, and
vehicle driving speed,
wherein the intermediate outputs of the supervised learning model comprise:
the calculated inner condenser power,
the calculated evaporator power, and
the calculated coefficient of performance of the H/P system,
and wherein the optimal control setpoints for the lower level control are at least:
rotation speed of the compressor,
superheat temperature of an evaporator,
condition of a heating valve device, and
condition of a dehumidification valve device.

20. The method according to claim 14, in a cooling mode,
wherein the inputs to the supervised learning model are the following parameters:
target evaporator air out temperature,
target blower speed,
target chiller coolant out temperature,
the chiller coolant in temperature,
the chiller coolant in mass/volume flow,
ambient temperature,
ambient humidity, and
vehicle driving speed,
wherein the intermediate outputs of the supervised learning model comprise:
the calculated chiller power,
the calculated evaporator power, and
the calculated coefficient of performance of the H/P system,
and wherein the optimal control setpoints for the lower level control comprise:
rotation speed of the compressor,
superheat temperature of an outer heat exchanger, and
superheat temperature of a chiller.

21. The method according to claim 14,
wherein a target inner condenser power is calculated based on a target inner condenser air out temperature, an ambient temperature, and a blower speed.

22. The method according to claim 14,
wherein a target outer condenser power is calculated based on a target outer condenser coolant out temperature, an ambient temperature, and a coolant flow volume through the outer condenser.

23. The method according to claim 14,
wherein a target evaporator power is calculated based on the target evaporator air out temperature, an ambient temperature, and a blower speed.

24. The method according to claim 14,
wherein a target chiller power is calculated based on a target chiller coolant out temperature, the chiller coolant in temperature and the chiller coolant in mass/volume flow.

25. The method according to claim 13, operating the thermal management system in an electric powertrain coolant system mode,
wherein the thermal system comprises am electric power train/battery coolant system,
wherein the inputs to the supervised learning model comprise the following parameters:
ambient temperature,
vehicle driving speed,
battery temperature,
electric powertrain temperature,
target chiller power,
target power for electric powertrain, and
target battery power,
wherein the calculated intermediate outputs of the data driven supervised learning model comprise:
calculated power consumption of an electric powertrain,
calculated power dispense of a battery, and
calculated power consumption of electric driven auxiliary components,
and wherein the optimal control setpoints for a lower level control comprise:
optimal valve device control parameter,
optimal electric heater control parameter,
optimal auxiliary components control parameter, and
optimal chiller power.
